(19) United States
(12) Patent Application Publication
(10) Pub. No.: US 2007/0233287 A1
(43) Pub. Date: Oct. 4, 2007

(54) Dynamic generation of tasks in resource constrained devices

(75) Inventors: Mithun Sheshagiri, Berkeley, CA (US); Anugeetha Kunjithapatham, Sunnyvale, CA (US); Alan Messer, Los Gators, CA (US)

Correspondence Address: Kenneth L. Sherman, Esq.;Myers Dawes Andras & Sherman, LLP, 19900 MacArthur Blvd., 11th Floor, Irvine, CA, 92612, US

(73) Assignee: Samsung Electronics Co., Ltd., Suwon City (KR)

(21) Appl. No.: 11/394,968

(22) Filed: Mar. 30, 2006

(51) Int. Cl. G05B 15/00

(52) U.S. Cl. 700/83

(57) ABSTRACT

A method and system for dynamic generation of tasks in resource constrained devices involves identifying tasks that can be performed by devices in a resource constrained network, wherein the tasks represent activities that can be performed by the devices. Tasks are generated using the capabilities of devices as each device is discovered in the network. A task uses one or more functionalities of one or more devices. Task generation specifically takes into account the limited memory and processing power which a typical home device possesses, and the tasks are generated dynamically.

### FIELD OF THE INVENTION

The present invention relates to task computing and in particular to dynamic generation of tasks in resource constrained devices.

### BACKGROUND OF THE INVENTION

A Task Computing system discovers services/devices in a network and composes tasks using these services. It further provides a means for executing these tasks. Conventional task computing systems have been designed for the office scenario involving items such as documents, projectors, PC, etc. This requires the task computing component to reside in a device used for interaction by the user, and makes it difficult to operate the task computing component on devices with limited computation power and memory.

Further, services that can be used by such conventional task computing systems have one input/output, which reduces the variety of tasks that can be composed. For example, a task may require an audio device and a separate video device to be connected to a streaming device. To enable this scenario, the streaming service has to be represented as a service with two outputs. The system automatically composes tasks that involve only two basic services and provides a manual way of composing tasks with more than two services. However, tasks that involve more than two services/functionalities cannot be composed automatically.

### BRIEF SUMMARY OF THE INVENTION

An object of the present invention is task composition, wherein given a set of devices, the present invention finds tasks that can be composed using the functionalities of the device. In addition, the present invention enables finding combinations of service/device functionality for a given task. Another objective of the present invention is providing a mechanism that allows automatic composition on resource constrained devices.

In one embodiment, the present invention provides a method and system for dynamic generation of tasks in resource constrained devices. An implementation of such dynamic generation of tasks involves identifying tasks that can be performed in a resource constrained network environment such as a home network environment. Tasks represent activities that can be performed in the home environment. Tasks are generated using the capabilities of devices as each device is discovered in the home network. A task uses one or more functionalities of one or more devices. Generation of tasks specifically takes into account the limited memory and processing power which a typical home device possesses. Further, tasks are generated dynamically.

In another aspect, dynamic generation of tasks in resource constrained devices according to the present invention, is optimized for speed to maintain the response time low. Since memory on device is a valuable resource, the present invention also enables managing memory that stores information about device capabilities efficiently.

Because the present invention takes into account that devices in the home network have limited computational and memory resources, dynamic generation of tasks according to the present invention can operate on household devices such as TVs, STBs, etc. Such dynamic generation of tasks further automatically composes tasks that involve an arbitrary number of services. Further, restrictions are not imposed on the number of inputs/outputs for a service.

These and other features, aspects and advantages of the present invention will become understood with reference to the following description, appended claims and accompanying figures.

### BRIEF DESCRIPTION OF THE DRAWINGS

FIG. 1 shows an example of a network implementing an embodiment of the present invention.

FIG. 2 shows a functional block diagram of an InterPlay Controller and Home task model for task generation, according to an embodiment of the present.

FIG. 3 shows functional block diagram of another example home network, embodying the present invention.

FIG. 4 shows a functional block diagram of an implementation of a Home task model for task generation, according to an embodiment of the present.

FIG. 5 shows a flowchart of the general steps implemented by the Home task model of FIG. 4, according to an embodiment of the present invention.

FIG. 6 illustrates the snapshot-based approach for reducing response time for task generation, according to an embodiment of the present.

### DETAILED DESCRIPTION OF THE INVENTION

In one embodiment, the present invention provides a method and system for dynamic generation of tasks in resource constrained devices. An implementation of such dynamic generation of tasks involves identifying tasks that can be performed in a resource constrained network environment such as a home network environment. Tasks represent activities that can be performed in the home environment. Tasks are generated using the capabilities of devices as each device is discovered in the home network. A task uses one or more functionalities of one or more devices. Generation of tasks specifically takes into account the limited memory and processing power which a typical home device possesses. Further, tasks are generated dynamically.

In another aspect, dynamic generation of tasks in resource constrained devices according to the present invention, is optimized for speed to maintain the response time low. Since memory on device is a valuable resource, the present invention also enables managing memory that stores information about device capabilities efficiently.

Because the present invention takes into account that devices in the home network have limited computational and memory resources, dynamic generation of tasks according to the present invention can operate on household devices such as TVs, STBs, etc. Such dynamic generation of tasks further automatically composes tasks that involve an arbitrary number of services/devices. Further, restrictions are not imposed on the number of inputs/outputs for a service/device. A service can comprise of some functionality offered by a device (e.g., a video screen for playing movie), a service can also be some Internet service (e.g., online shop, etc.), etc. Device functionality and service mean the same at a broader level.

Referring to the drawings, an example implementation of dynamic task generation in resource constrained devices in a home network, according to the present invention is now described. Such a technique for generating tasks in a home network environment includes the following task generation aspects: (1) Dynamic generation of task suggestions based on device and task descriptions, and device constraints, and (2) Operation in a resource constrained environment. Each task suggestion represents a user task. A task suggestion is represented using a language structure organized as a set of terms to describe user tasks as abstractions of the obtained device function descriptions and task descriptions, and device constraints.

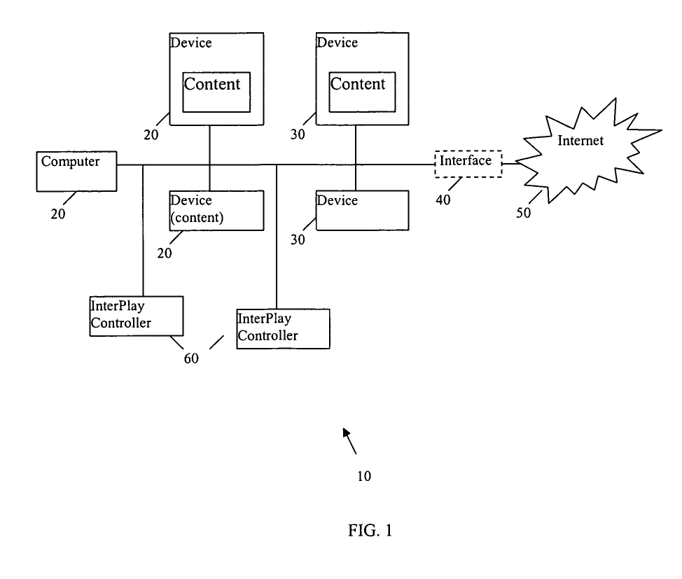

FIG. 1 shows an example functional architecture of a network 10, such as a home network, that implements dynamic task generation in resource constrained devices, according to an embodiment of the present invention. The network 10 comprises devices 20 (e.g., including content) and devices 30 (e.g., client device having a visual interface to display the client GUI to the user), and optional interface 40 that connects the network 10 to another network 50 (e.g., another home network, the Internet, etc.). Though the devices 20 and 30 are shown separate, a single physical device can include one or more client devices and/or one or more server devices.

The devices 20 and 30, respectively, can implement the HTTP protocol for communication and protocol there between. Though in the example described herein the HTTP protocol is utilized by the network 10, those skilled in the art will recognize that the present invention is useful with other network communication protocols that utilize the client-server model. An example device 20 can be a VCR, DVD, computer, etc. Further, an example client device 30 can be a TV, computer, etc.

The network 10 further includes at least one InterPlay Controller (IC) 60 that suggests tasks for the user to perform. As described further below, a task comprises pseudo-sentence based representation of activities that can be performed using devices. For example, if one has a TV and a DVD player then “Play Movie on TV” is a task. Examples of tasks are provided in commonly assigned patent application titled “Method and system for presenting user tasks for the control of electronic devices,” Ser. No. 10/947,774 filed on Sep. 22, 2004, commonly assigned patent application titled “A method and system for describing consumer electronics using separate task and device descriptions,” Ser. No. 10/950,121 filed on Sep. 24, 2004, commonly assigned patent application titled “A method and system for the orchestration of tasks on consumer electronics,” Ser. No. 10/948,399 filed on Sep. 22, 2004, commonly assigned patent application titled, “Contextual task recommendation system and method for determining user's context and suggesting tasks,” Ser. No. 11/200,546 filed on Aug. 9, 2005, and commonly assigned patent application titled, “Method and system for prioritizing tasks made available by devices in a network,” Ser. No. 11/200,547 filed on Aug. 9, 2005 (all incorporated herein by reference).

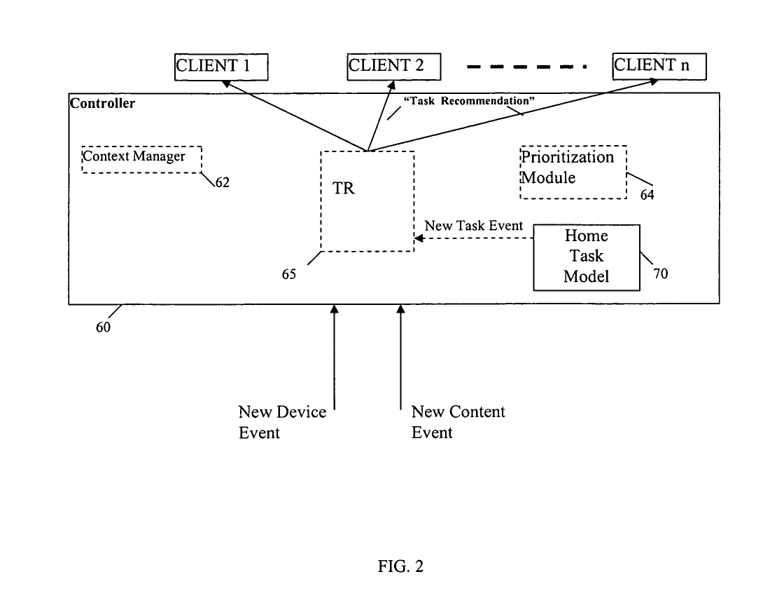

FIG. 2 shows a function block diagram of the InterPlay Controller 60 which interacts with client programs (e.g., CLIENT 1, CLIENT 2 . . . CLIENT N) in the network 10. The controller 60 includes a Home task model (HTM) 70 that generates tasks.

Tasks are generated when new device or content is detected. Once the devices in the home network are discovered, the HTM 70 gathers the task and device descriptions from the devices and determines the tasks achievable in the home network based on these descriptions. The HTM 70 obtains: (1) device function descriptions, wherein each device function description describes a function that a device can perform, and (2) task descriptions, wherein each task description describes the device functionality a certain task requires. The HTM 70 then generates combinations of tasks, wherein a task comprises a user friendly description of the high-level actions a user can performs using the devices. In one example the user friendly description comprises a task suggestion based on the obtained task descriptions and device function descriptions (i.e., each task suggestion represents a user task based on one or more of the obtained device function descriptions and task descriptions). The combinations of tasks generated by the Orchestrator module are called task combinations (TC) and the set of devices needed to execute a task combination are referred to as device combinations.

The controller 60 may optionally include a context manager 62 that gathers user context information such as the location and the device used by the user, a prioritization module 64 that provides a prioritized list of tasks by context and a Task Recommender (TR) 65 that provides task recommendations to clients. The TR 65 suggests tasks in accordance with certain policies. The TR 65 can be triggered via a New Device Event or a New Content Event whenever a new device or new content, respectively, is discovered in the network. Typical user activities that can trigger the TR 65 include e.g. turning a TV ‘ON’, inserting an Audio CD into a device, etc. The determination of context and the recommendation of tasks are performed by keeping track of the content and the devices available to the user at any given time. The controller 60 may also make use of the prioritized list of tasks by context provided by the prioritization module 64, to change its operation accordingly, such as suggesting tasks using the optional TR 65 based on correlated changes.

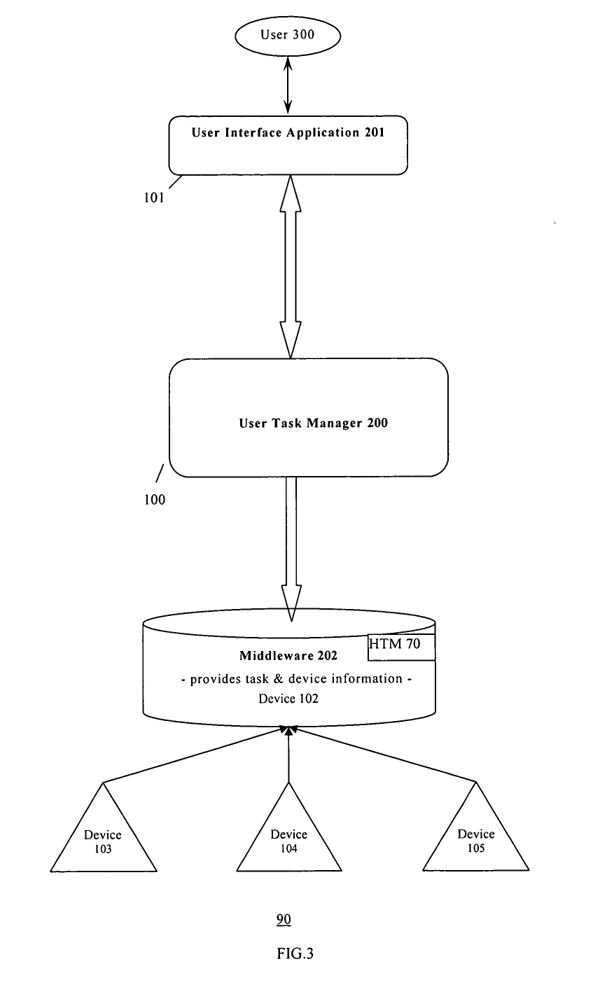

As shown by the functional block diagram in FIG. 3 of another home network 90 embodying the present invention, the HTM 70 is part of a middleware 202 developed to ease the use of devices in a home environment. The middleware 202 is designed to reside in home devices 102 such as STBs, PVRs, TVs, etc.

The middleware 202 discovers various devices in the network 90, provides an application programming interface (API) that is used to control devices 102-105 in the network 90, and aggregates the content residing on the devices 102-105 in the network 90.

A User Task Manager (UTM) 200 provides interfaces for user interface applications to access and execute tasks available in the home network 90 utilizing devices (e.g., devices 103, 104, 105, etc.) in the network 90. In one example, a task is represented as a combination of a verb, subject, devices and attributes. A User Interface is the interface between a user and a computer program, which is supported by a User Interface Application (UIA) 201. The UTM 200 provides functionality and interface to support that UIA 201. The UIA 201 and the UTM 200 may reside on the same or different devices in the network 90. In the example shown in FIG. 1, the UIA 201 resides on a device 101 in the network 90, and the UTM 200 resides on device 100 in the network 90. In operation, a user 300 starts the UIA 201 for interaction with network 90.

The HTM 70 in conjunction with UTM 200 simplify user access to the devices and content in the home network 90. The HTM 70 and UTM 200 communicate with other modules in the middleware 202 by invoking functions provided by the interface (i.e., interfaces of internal modules that abstract device controls). Asynchronous communication between the HTM 70 and other modules in the middleware 202 is performed through events. First, the HTM 70 conveys its interest in certain state variables by registering with the middleware 202 for events associated with these variables. When the state of any of these variables changes, the HTM 70 is informed by the middleware 202 of this change via events.

A task herein represents an activity that can be performed in the home network environment, such as playing a movie on a particular device or printing a picture on a printer, etc. In one example, a verb, a subject, a list of devices that perform the task and information about the devices forms a task. Of these the subject, verb, device name and attributes of the devices are the only ones shown to the user. The task is shown to the user in the form of pseudo-sentences. For example, the sentence “Play a movie in the living room TV” is represented as “Play Movie LivingRoomTV”. These tasks are generated by the HTM 70 using device and task descriptions. In one example, the HTM 70 uses a rule-based knowledge processing entity (or a similar description) to generate tasks.

A device description includes information such as device name, capabilities, attributes and descriptions that help to invoke capabilities and attributes. Task descriptions include information regarding the functionalities required for a specific task. In the example of FIG. 3, the device and task descriptions are provided to the HTM 70 by the device 103-105 when they are turned ON. The task and device descriptions are removed from the HTM 70 when devices are switched OFF. The HTM 70 also contains a rule-based knowledge base (KB) for storing device/task descriptions and for inferencing in task generation.

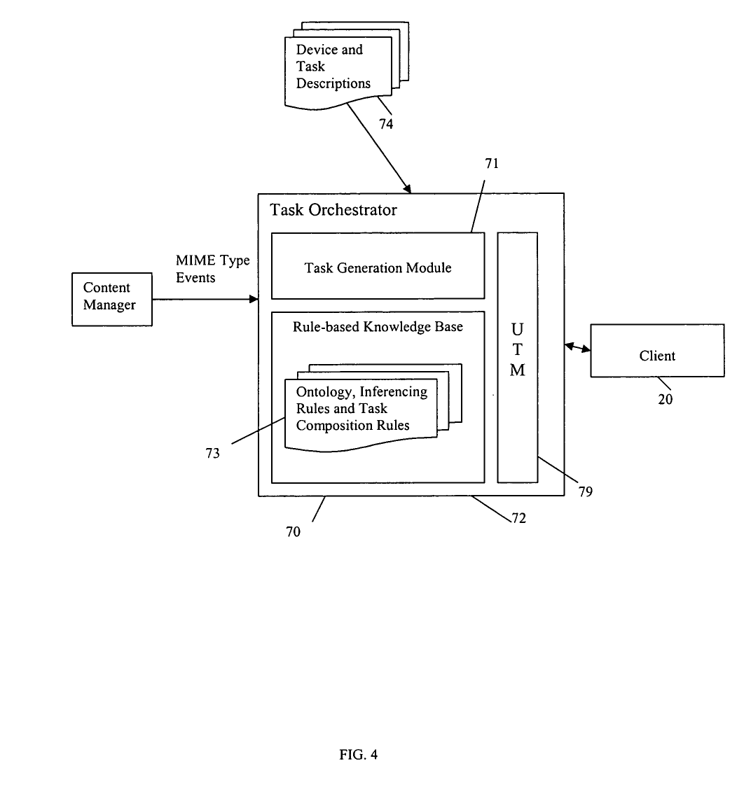

An example of dynamic task generation by the HTM 70 based on task descriptions and device descriptions, according to the present invention, is now described. FIG. 4 shows an example functional block diagram of an implementation of the HTM 70 including a task generation module (TGM) 71 and Rule-based Knowledge Base (KB) 72. The Rule-based Knowledge Base 72 includes Ontology, Inferencing Rules and Task Composition Rules 73. The HTM 70 receives Device and Task Descriptions 74 to generate tasks, and interacts with a client device 20.

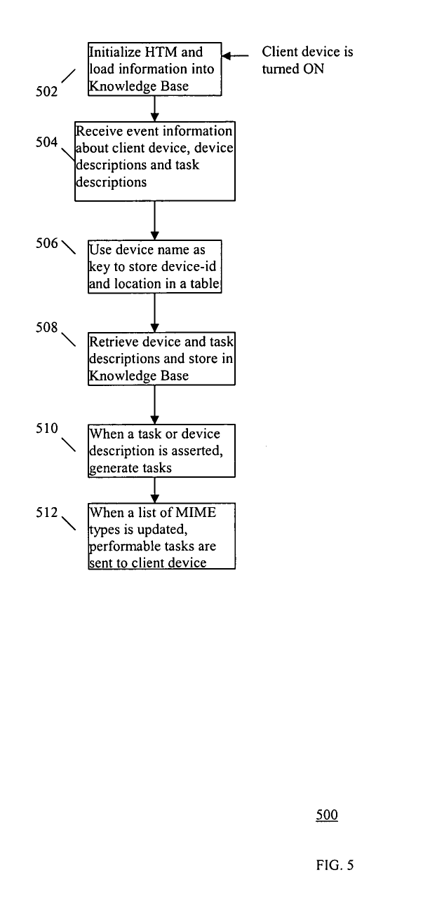

The flowchart 500 in FIG. 5 shows an embodiment of steps performed by the HTM 70 to dynamically generate tasks according to the present invention when the device 20 in the home network is turned ON, showing how tasks are generated and shown to the client, wherein:
Step 502: Initialize the HTM 70 and during that initialization load the following information into the KB 72:
   a. An ontology file that defines concepts used to describe device and task descriptions. Information in this file is also used for inferencing utilizing the knowledge base and the rules loaded during initialization;
   b. A file containing rules to determine tasks from device functionalities and task requirements;
   c. A file containing rules that perform inferencing over the facts introduced by the device and task descriptions; and
   d. Files containing queries used for extraction information in the KB 72.
Step 504: The task generation module 71 receives event information about the device 20 (device name, device id, location, etc.) and the location of the device and task descriptions 74. Further, the client device connects to HTM 70 via UTM 79 after initialization of HTM 70. The client device connects to HTM 70 and provides device and task description. The client device connects to the UTM 79 and registers itself with information that is used by UTM 79 to send events later.
Step 506: The name of the device is used as a key to store the device-id and location in a table.
Step 508: Each task and device description is then retrieved from its physical location and asserted into the KB 72. The description files are retrieved using the location address provided in step 503.
Step 510: Every time a task or device description is asserted (described further below), the following sequence of steps are performed by the TGM 71 to generate the tasks from the device and tasks description:
   e. The state of the KB 72 just before assertion is recorded.
   f. The device and task description is asserted into the KB 72, and inferencing and task related rules are applied.
   g. The state of the KB 72 is again recorded and the difference in the state in step 510a and step 510c is used to obtain identification of facts (described further below) that make up the device or the task description. This information is stored in a fact-id table in the TGM 71.
   h. All device and task related information stored as fact information in the KB required to form a task are extracted from the KB and stored in various tables outside KB. These tables are part of TGM 71 and basically a duplicate copy (snapshot) of all the device and task information outside the KB. An example list of tables includes:
      Task-key table, which contains all the task-keys generated. Task-key table lists task-key, subject of the task, verb of the task and list of functionalities required for the task.
      Fact-id table, which contains mapping between device-name and the ids of all the facts that correspond to the device. Given a device name, the range of facts that hold all information about the device are stored. Device-info table, which contains mapping between device name and information about attributes and grounding. Given the device name, its attributes and grounding information can be retrieved. It also has information regarding MIME-types. Func-dev list is a table that contains mapping between Functionality and devices that offer that functionality. Given the functionality, the table provides all devices that offers that functionality.
   i. Given a set of requirements for a task, the rules loaded during initialization only determine if device functionalities exist in the network to fulfill the task requirements. For example, Play Movie requires an Audio Renderer and a Video Renderer. This is the requirement for the task. It is represented in the task description file which is converted to facts in the KB. The actual construction of the task is performed outside the KB 72 in step 512i. The KB72 stores facts and executes the rules, checks to see if the task can be achieved. For example, if there is a Play Movie task and there is a AudioRenderer and a VideoRenderer then, then the KB determines that Play Movie is possible and generates a task-key. The task-key points to the subject verb combination possible in the home network. Utilizing the KB, the rules also generate keys for possible tasks, termed task-keys. These keys are hooks to all the tasks in the network. Using the task-key, subject, verb and the required functionalities can be queried from the KB.
   j. Inferencing rules infer new facts about the client device 20 and the task.
   k. The TGM 71 gathers task and device information from the KB 72. The information is a collection of asserted and inferred facts.
   l. The TGM 71 takes each task-key generated in step 510d and gathers the functionalities for that particular task.
   m. For each functionality required by the task, a list of devices that offer that functionality is created by the TGM 71. This is referred to as the func-dev list. The number of func-dev lists is the same as the number of functionalities required to achieve the task.
   n. Using the func-dev lists, a combination of devices is built by the TGM 71 where the one device (e.g., any device with functionality, such as VRenderer, ARenderer, Printer, etc.) from each func-dev list is picked by the TGM 71.
   o. Using the task-key, the TGM 71 extracts the subject and verb information using the task-key table, and using the device name, the TGM 71 acquires attribute and grounding information from the Device-info table. This information was stored in step 510d by the TGM 71.
   p. The task contains a set of MIME types in Dev-info table. The set of MIME types for a task are obtained from the intersection of sets of MIME types obtained from each device in the network.
   q. The TGM 71 also maintains a list of MIME types available in the network from the underlying middleware 202.
   r. For each task generated by TGM 71,the TGM 71 performs the following checks and actions wherein tasks are presented to the user only if they can be executed:
      1. If the task contains a MIME type available in the network AND the task is not known to the client, then the task is sent to the client. The UTM 200 identifies if a task is known to the user. Information regarding whether the user already knows about the task is known to UTM 200. For example, if the user already knows about “Play Music” then the “Play Music” task is not sent to the user.
      2. If the task does not contain MIME types that are currently available in the network, then the task is not sent to the client but stored internally in the HTM 70.
      3. If the user client contains a task which is not available with HTM 70, the task is deleted. In one example, the user has a DVD player and a TV wherein the HTM 70 generates a “Play Movie” task. If the user unplugs the DVD player, then there is no movie in the system and therefore HTM 70 deletes the “Play Movie” task and informs the client to delete that task.
Step 512: When a list of available MIME types is updated by the HTM 70, tasks that can be performed due to the availability of new MIME types are sent by UTM 79 to the client device used by user to view tasks and execute them. The HTM 70 uses software that keeps track of content in the home.

Referring back to steps 510r.1-3 above, in one example of the network includes a DVD player and a TV but no DVD, then steps 510r.1-3 ensure that a DVD task is not shown to the user. When a TV and a DVD player are hooked to the network, the TGM 71 knows that Play Movie is possible and therefore generates it. But, it does not show the task to the user until DVD content is seen by the TGM 71.

When the device 20 is turned OFF, using the fact-id table, device and/or task descriptions are deleted and step 510 above is repeated and tasks are deleted (see step 510n.3).

As used herein, Assertion is the process of loading facts into a knowledge-base system. Facts include a format for entering information into a knowledge base. Knowledge base is a type of a system that can store facts and apply rules to these facts. For example:

Facts:

A brotherOf B

Rule:

If x brotherOf y=>y brotherOf x

Loading the fact above (A brotherOf B) into the KB along with the rule, then the KB will match A brotherOf B with the LHS of the rule and fire the RHS i.e., it will infer B brotherOf A.

Fact is the terminology to represent information in a format that can be understood by the (knowledge base) KB. For example, to store and infer information about fruits, a format is utilized to represent information. For example, the format an be X relationName Y. This can be used to define relations. Given format Fruit color ColorName, one can create facts: Bananas color Yellow, Orange color Orange. The way fact is represented in the present invention is not important.

Inferencing new facts infer new information about the device. For example, if a Play Movie requires an ARenderer and VRenderer and a device (TV) is a AVRenderer, there is rule in the KB which states that AVRenderer is the same as ARenderer and VRenderer. As such, if (TV isA AVRenderer) is a fact introduced by the device description and there is a rule in the KB which states:

If X isA AVRenderer =>

Create new fact (X is ARenderer) AND

Create new fact (X is VRenderer)

Then when this rule fires, there will be two new (inferred) facts:

TV isA ARenderer

TV isA VRenderer

As noted, dynamic task generation according to the present invention is able to function in a resource constrained environment, including devices with limited processing power and memory. Response time is critical in interactive applications. The memory required to load the entire end-to-end task generation component including the middleware 202, the HTM 70 and interface components 200, 201, is fixed in size. Additional memory is required as the task generation component detects new devices and adds the information provided by them to the KB 72. Therefore, the additional memory required is directly proportional to the number of devices that operate simultaneously.

The number of devices in the home network is always limited. Even if there are a large number of devices, the number of devices being used simultaneously is small. This observation is utilized in determining memory needs, to improve the response time in task generation according to the present invention. The memory needs are determined by pre-computing all the possible tasks that can be achieved in the home network given the devices that are online (connected and turn on) in the network. As a result, requests by the client device for tasks or task related information only packaging the data and sending the response. There is no additional processing involved. This reduces the response time, making the task generation component highly interactive. Whenever the client asks for information, data is only packaged—no additional computation is performed. In one embodiment, generation of tasks is done when devices are added and not when user asks for them.

The KB 72 is further appropriate for performing certain operations such as firing rules and managing facts. However, managing and accessing arbitrary data-structures can be performed efficiently in Java. Therefore, an example embodiment of the present invention uses the KB 72 as a store for facts and inferencing using rules. Once the inferencing is done, a snapshot of the part of the data is serialized into instances of Java classes.

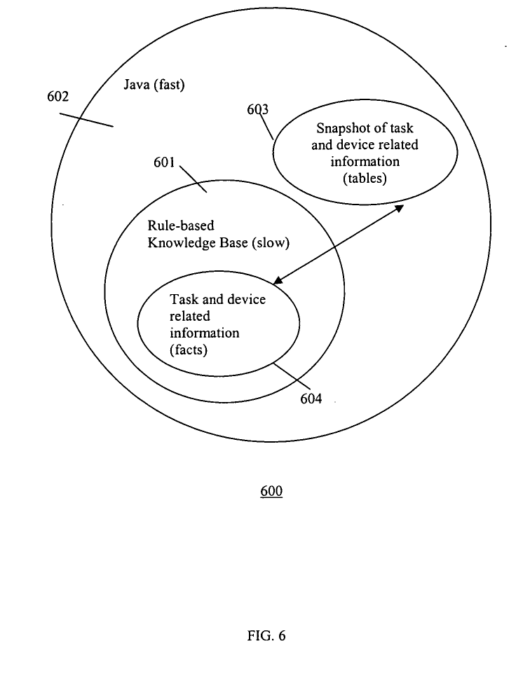

The example 600 in FIG. 6 illustrates the snapshot-based approach for reducing response time. Information in the snapshot (tables) and not facts 604 in the KB 72 are used for generating tasks, and transformation of tasks into messages for the client device (i.e., communication between client device and the HTM 70 is via the UTM 79 using events and method calls). This enables conveying information to the client without making calls to the KB 72, thereby reducing response time of calls made to HTM 70 by the client. In FIG. 6, the slow area (KB area) 601 is used when a device is added. The fast environment (outside KB) is used while interacting with the client device. When the client asks for data, it is fetched from the snapshot 603. Most of processing occurs (in the slow environment) when a device is added and less processing (in the fast environment 602) is performed while interacting with the client. These ensure that interaction between client and HTM is quick.

By accounting for the asserted and inferred facts (see steps 510b and 510c) and deleting them when devices are turned OFF, it is assured that there is no memory leakage and the memory foot-print does not grow as devices are added and deleted from the network over time.

While the present invention is susceptible of embodiments in many different forms, there are shown in the drawings and herein described in detail, preferred embodiments of the invention with the understanding that this description is to be considered as an exemplification of the principles of the invention and is not intended to limit the broad aspects of the invention to the embodiments illustrated. The aforementioned example architectures above according to the present invention can be implemented in many ways, such as program instructions for execution by a processor, as logic circuits, as ASIC, as firmware, etc., as is known to those skilled in the art. Therefore, the present invention is not limited to the example embodiments described herein.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of generating user tasks to be performed by one or more of a plurality of resource constrained electronic devices in a network, the method comprising the steps of:
obtaining device function descriptions, wherein each device function description describes a function that a device can perform;
obtaining task descriptions, wherein each task description describes the device functionality a certain task requires;
generating task suggestions based on the obtained task descriptions, the obtained device function descriptions and resource constraints of one or more of the devices, such that each task suggestion represents a user task.

2. The method of claim 1 wherein each task suggestion represents a user task based on one or more of the obtained device functions descriptions, task descriptions and resource constraints of one or more of the devices.

3. The method of claim 1 wherein said resource constraints include memory constrains of a device.

4. The method of claim 1 wherein said resource constraints include processing power of a device.

5. The method of claim 1 further comprising the steps of managing device memory that stores information about device functions.

6. The method of claim 1 wherein the step of generating task suggestions further includes the steps of automatically generating tasks suggestions based on an arbitrary number of services.

7. The method of claim 1, further comprising the steps of:
displaying task suggestions on a display for the user to select from, wherein the user selected task suggestion is to be performed by one or more of the devices.

8. The method of claim 7, wherein the step of displaying the task suggestions further includes the steps of displaying task suggestions for tasks that can be performed by the available devices.

9. The method of claim 1, wherein a task suggestion is represented using a language structure organized as a set of terms to describe user tasks as abstractions of the obtained device function descriptions and task descriptions.

10. A system for generating user tasks to be performed by one or more of a plurality of resource constrained electronic devices in a network, comprising:
means for obtaining device function descriptions, wherein each device function description describes a function that a device can perform;
means for obtaining task descriptions, wherein each task description describes the device functionality a certain task requires;
means for generating task suggestions based on the obtained task descriptions, the obtained device function descriptions and resource constraints of one or more of the devices, such that each task suggestion represents a user task.

11. The system of claim 10 wherein each task suggestion represents a user task based on one or more of the obtained device functions descriptions, task descriptions and resource constraints of one or more of the devices.

12. The system of claim 10 wherein said resource constraints include memory constrains of a device.

13. The system of claim 10 wherein said resource constraints include processing power constraints of a device.

14. The system of claim 10 further comprising means for managing device memory that stores information about device functions.

15. The system of claim 10 wherein the means for generating task suggestions further automatically generating tasks suggestions based on an arbitrary number of services.

16. The system of claim 10, further comprising means for displaying task suggestions on a display for the user to select from, wherein the user selected task suggestion is to be performed by one or more of the devices.

17. The system of claim 16, wherein the means for displaying the task suggestions further displays task suggestions for tasks that can be performed by the available devices.

18. The system of claim 10, wherein a task suggestion is represented using a language structure organized as a set of terms to describe user tasks as abstractions of the obtained device function descriptions and task descriptions.
